(19) United States
(12) Patent Application Publication
(10) Pub. No.: US 2002/0113773 A1
(43) Pub. Date: Aug. 22, 2002

(54) Electronic whiteboard

(76) Inventors: James Thomas Edward McDonnell, Bristol (GB); Michael Christopher McTernan, Nr. Carnforth (GB)

Correspondence Address: HEWLETT-PACKARD COMPANY, Intellectual Property Administration, P.O. Box 272400, Fort Collins, CO, 80527-2400, US

(21) Appl. No.: 10/073,890

(22) Filed: Feb. 14, 2002

(30) Foreign Application Priority Data
Feb. 22, 2001 (GB) 0104307.4

(51) Int. Cl. G09G 5/00

(52) U.S. Cl. 345/156

(57) ABSTRACT

An electronic whiteboard (2) having a data store (6, 28) for storing images recorded on the whiteboard, which data store (6, 28) has a presence on a network, for example the internet via a unique network location or URL. In one preferred embodiment the electronic whiteboard includes a network server for the data store and the server has a unique network location or URL. In a second preferred embodiment the data store (6, 28) has a presence on the network via a remote server (26) which acts as a gateway from the network to the data store (6, 28) and the server has a presence on the network, defined by a unique network location or URL. Thus, an authorised person, in any location and at any time can access the data store (6, 28) of the electronic whiteboard (2) simply by accessing the network and inputting the unique network location or URL associated with the data store (6, 28)

The present invention relates to an electronic whiteboard, on which images, including letters and numerals, can be recorded and viewed simultaneously by a group of people, who may or may not be colocated.

Images are generally recorded on an electronic whiteboard by an associated pen device which is moved over the surface of the whiteboard. The location of the pen device is sensed by the whiteboard and the whiteboard responds by marking the parts of its surface over which the pen device travels. In this way writing or drawings made by a user of the pen device on the surface of the whiteboard are recorded by the whiteboard.

Electronic whiteboards are often used during a meeting or a brainstorming session to record issues that have been discussed at the meeting. The whiteboard can be viewed by all attendees at the meeting during the course of the meeting, to keep the issues recorded on the whiteboard in the minds of the attendees. The images recorded on the whiteboard can then be saved into a data store, from which they can be printed, or E-mailed or faxed to interested parties

Electronic whiteboards are also used in teleconferencing facilities so that issues raised in the teleconference can be recorded or can be better communicated through images drawn on the whiteboard. However, existing teleconferencing facilities utilising electronic whiteboards can require specialised communication hardware which impair widespread use, are essentially immobile making it difficult for a mobile worker to use, consume substantial communication bandwidth and use expensive communications hardware. These problems are addressed in WO 96/37068 which relates to a method for facilitating data communication between remotely located conference participants. The problems are solved by a database of images being collected prior to a meeting and circulated to all participants of the meeting, eg. by E-mail, so that each participant holds a set of the images locally before the meeting. The images can then be looked at simultaneously by all participants during a teleconferencing session. However, this system has the disadvantage that no new images can be created and no changes can be made to the images during the course of the meeting and that viewing of the same image by all participants at the same time requires co-ordination.

U.S. Pat. No. 5,956,487 discloses devices, such as office equipment, within which web functionality is embedded to enable low cost widely accessible and enhanced user interface functions for the device. The user enters a URL corresponding to the device in order to access the device via a web browser. This enables such devices to have improved user interfaces for the operation of the devices and enables such devices to be accessed and operated remotely. U.S. Pat. No. 5,956,487 does not discuss electronic whiteboards, however, incorporating web functionality into a whiteboard in accordance with U.S. Pat. No. 5,956,487 could improve the user interface to facilitate use of the whiteboard.

According to a first aspect of the present invention there is provided an electronic whiteboard including a data store for storing images that are recorded on the whiteboard wherein the data store has a presence on a network via a unique network location or URL. The electronic whiteboard could be operated in the usual way, via a user interface, to create images, store the images in the data store, print, fax or E-mail the images to interested parties. However, the electronic whiteboard according to the present invention has the additional feature that the data store of the electronic whiteboard can be accessed remotely in order to access images stored in the data store, in particular some time after the whiteboard was in use to create the images.

In one preferred embodiment the electronic whiteboard includes a network server which server has a network location or URL for providing access to the data store via the network. In a second preferred embodiment the data store has a presence on the network via a remote server which acts as a gateway between the network and the data store and the server has a presence on the network, defined by a unique network location or URL.

Thus, at any time after a meeting during which the whiteboard was in use, an individual in any location can access the data store of the electronic whiteboard using the network location or URL associated with the data store of the whiteboard.

Some form of security system would need to be implemented in order to provide access to the data store of the electronic whiteboard only to authorised individuals, in order to preserve confidentiality.

In a preferred embodiment of the present invention, the data store stores images recorded on the whiteboard, preferably periodically, but alternatively in response to an input by a user of the whiteboard.

In a preferred embodiment of the present invention, which is particularly suited for use in teleconferencing, images recorded on the electronic whiteboard are stored into the data store in real time. This enables a remotely located individual, with access to the network, to access the data store to view the images recorded on the whiteboard as they are recorded. If this remotely located individual is in telephonic communication with one or more individuals using the whiteboard, then a teleconferencing service is provided.

The images may be stored in the data store under a file name or heading incorporating the time and date of the meeting at which the images were, or are being, made, as well as optionally some form of descriptive title. This would facilitate access over the network to the correct part of the data store.

Preferably, the electronic whiteboard additionally incorporates a communication system for communicating to individuals or computing devices within its locality the unique network location or URL of the data store. In one preferred embodiment, the electronic whiteboard includes a beacon for emitting a signal from which the unique network location or URL associated with the data store can be derived. Alternatively, the electronic whiteboard may include an electronic tag or bar code unit from which the unique network location or URL associated with the data store can be derived.

According to a second aspect of the present invention there is provided a method setting up an electronic whiteboard which whiteboard includes a data store for storing images recorded on the whiteboard, including the step of associating a network location with a network server for the data store. The network server may act as a gateway server between the network and the data store. Alternatively, the network server may be incorporated within the electronic whiteboard.

According to a third aspect of the present invention there is provided a method of accessing images recorded on or stored within a data store of an electronic whiteboard, including the step of inputting into a network browser which is connected to the network, a network location of a server for the data store.

As noted above, some form of security system would have to be implemented in order to restrict access to the data store to authorised individuals, in order to preserve confidentiality.

The network referred to above may be the public Internet. Alternatively, the network referred to above may be an intranet, for example a company intranet implemented with a variety of communication mechanisms including large area networks connected together by various types of communications. The data from the data store can be packaged using the Hyper-Text Markup Language (HTML) and can be transported over the network according to the Hyper-Text Transfer Protocol (HTTP). Using the HTML and HTTP Protocols enables communication of the data from the data store to existing web browsers.

In order that the present invention is more fully understood and to show how the same may be carried into effect, reference shall now be made, by way of example only, to the accompanying figures, wherein:

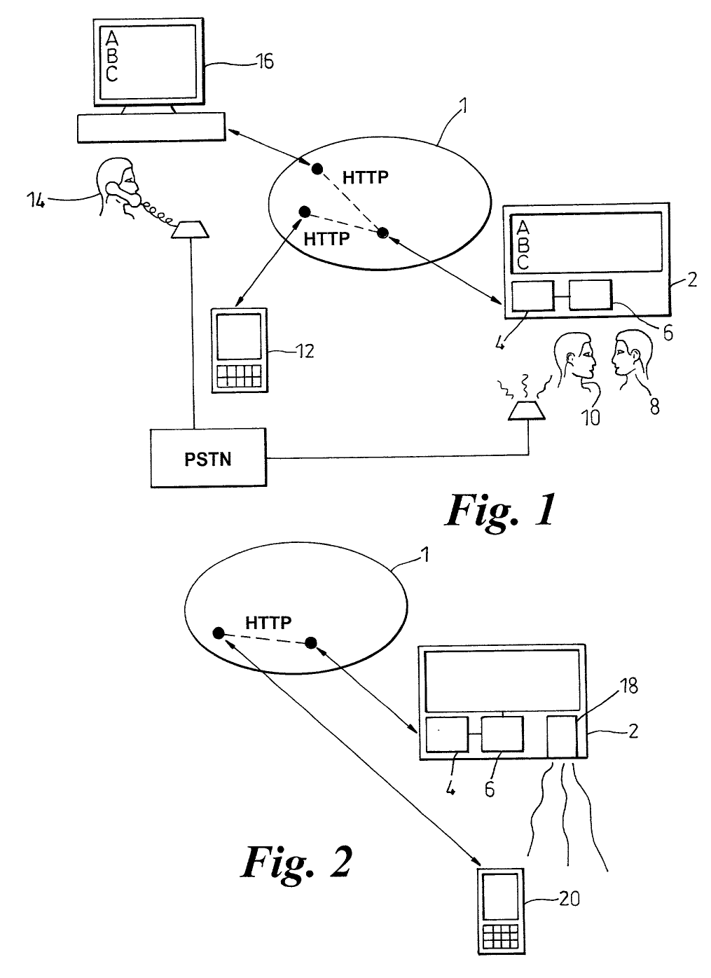

FIG. 1 shows a schematic representation of an electronic whiteboard according to the present invention having a data store which has a presence on a network, via a network server incorporated within the whiteboard and having a unique network location or URL associated with it;

FIG. 2 shows an electronic whiteboard similar to that shown in FIG. 1 which additionally incorporates a beacon for emitting the network location associated with the data store;

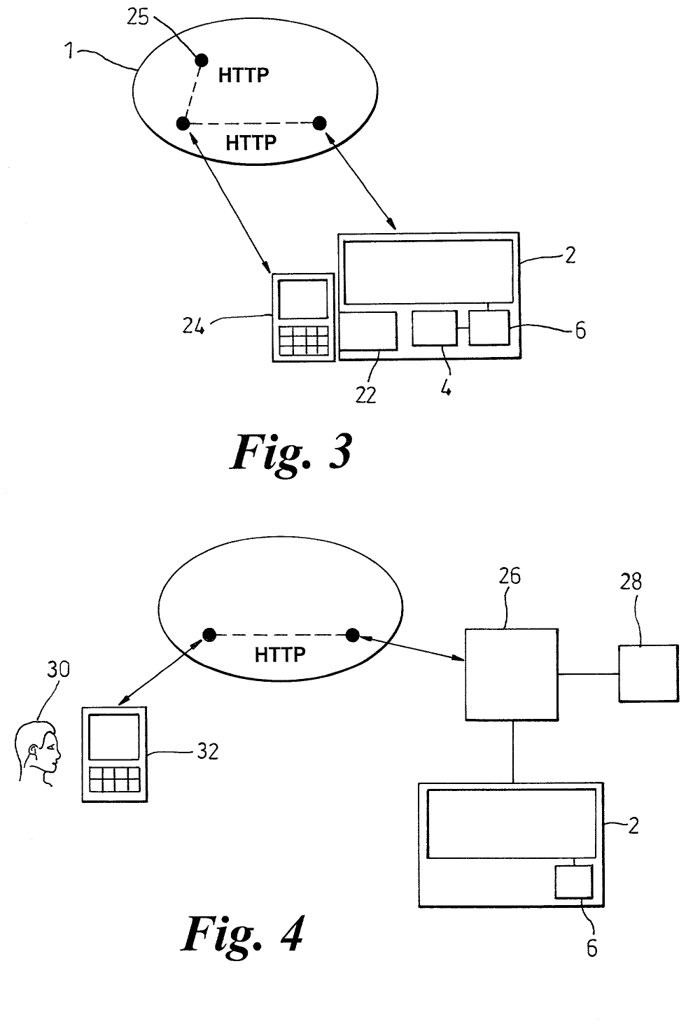

FIG. 3 shows an electronic whiteboard similar to that shown in FIG. 1 which additionally incorporates a bar-code or electronic tag encoding the network location of the data store; and

FIG. 4 shows an electronic whiteboard according to the present invention with a data store which has a presence on a network, via a network server which acts as a gateway to the data store.

FIG. 1 shows an electronic whiteboard (2). The whiteboard periodically saves the images which are recorded upon it within a data store (6). An Internet server (4) is incorporated into the whiteboard and has a unique Internet location or URL associated with it. The data store (6) of the whiteboard (2) is electronically readable via HTTP operations using the URL of the server (4). Thus, when the white board (2) is used to record information during the course of a meeting, at any time after the end of the meeting, the data store (6) to which the images from the white board have been saved can be accessed by an authorised individual in any location who has access to the Internet (1) and who knows the URL of the server (4). It should be noted that some form of security system would be required to limit access to the data store (6) by unauthorised individuals in order to preserve the confidentiality of the images stored in the data store (6).

For example, an attendee (8, 10) of the meeting carrying a mobile computing device (12) which device incorporates a world wide web browser could, when the browser is connected to the Internet, access and download the whiteboard images from the data store (6) of the whiteboard (2) by inputting the URL of the server (4). If a security system was implemented to preserve the confidentiality of the contents of the data store (6), then the attendee would also have to supply some forrn of authorisation key or password, in order to access the data store (6).

The electronic whiteboard (2) will be used at many meetings and so the data store (6) will contain images recorded at many meetings. Some form of convention would have to be applied when naming the files within the data store within which each meeting's set of images are stored. This would enable the correct set of images to be quickly identified by an individual accessing the data store (6) over the Internet. For example, the date and time of the meeting and optionally a descriptive title agreed at the meeting could be used as the heading or file name associated with a data file containing the images recorded during the meeting.

If the images recorded on the electronic whiteboard (2) are saved to the data store (6) in real time, then while the meeting is ongoing, a remotely located individual (14) connected to the Internet (1), for example via a computing device (16), can remotely view the images as they are recorded onto the whiteboard (2). The remote user would do this by keying in the URL of the server (4) into a world wide web browser running on the computing device (16) and connected to the Internet. The remote user could then access the data store (6) of the whiteboard (2). The file within the data store (6) into which the images are being saved in real time could then be accessed by the remotely located individual (14) so that the individual could view the images as they are being made. If this remote user (14) is in telephone communication with the meeting, for example via the PSTN as shown in FIG. 2, or is in communication with the meeting via a web cam, then the whiteboard (2) can also be used for teleconferencing. Again, if a security system is implemented, the individual (14) would have to supply an authorisation key or password in order to access the data store (6).

In an embodiment of the present invention shown in FIG. 2, the whiteboard (2) incorporates a beacon (18), which emits a receivable signal carrying the URL of the server (4) to all receiving entities in its vicinity. The signal emitted by the beacon (18) could also carry a file name to which the images currently recorded on the whiteboard (2) are or will be saved to. As an example, the beacon (18) could be an infra-red beacon configured to emit a URL, and optionally a file name, to any infra red sensor placed near the beacon or close to the beacon. For example, a member of the meeting may have a mobile computing device (20) which incorporates an infra-red sensor. If the beacon (18) is a broadcast beacon, which advertises the URL of the server (4) to all devices within its range, at the meeting the computing device (20) would automatically pick up and store the URL, and optionally a file name, emitted by the beacon (18). Alternatively, the computing device (20) may have to be directed towards the beacon (18) and operated by its user in order to pick up and store the signal emitted by the beacon (18).

At some later time, if the computing device (20) incorporates a web browser it could be connected to the Internet and be used to access and download the whiteboard images from the data store (6) of the whiteboard (2) using the previously stored URL associated with the server (4). If a file name was also previously stored, then this file name could be input to immediately locate the required data file within the data store (6) of the whiteboard (2). Otherwise, the required data file could be located with reference to the date and time of the meeting and/or the topic which was under discussion at the meeting. If the mobile computing device (20) cannot be used to access the Internet, then the previously stored URL and optionally a file name, could be downloaded or transferred from the mobile computing device (20) to another computing device which does have access to the Internet. This other computing device could then be used to access and download the required images from the data store (6) of the electronic whiteboard (2).

As an alternative to a beacon, the whiteboard (2) could include an electronic tag or a UPC (Universal Product identification Code) bar-code unit (22), as shown in FIG. 3. An electronic tag unit is a small device that supplies a unique identification string (like a bar-code) or a URL to a sensor placed near to or in contact with the whiteboard (2). In this case the user of a mobile computing device (24) incorporating an appropriate sensor or bar-code reader, would link the computing device (24) to or locate the computing device (24) in an appropriate location close to the whiteboard (2) in order to pick up the identification string, bar-code or URL. The identification string could then be sent to a tag resolving server (25) on the Internet in order to obtain the URL of the whiteboard (2). Then the URL could be used as described above to access and download data from the data store (6) of the whiteboard (2) via the server (4).

Any communication mechanism appropriate to communication within a local vicinity can be employed. In addition to infrared communication (limited by line of sight), a particularly effective alternative is low power wireless communication (using a short range protocol such as Bluetooth)—this is an effective choice with electronic tags. It should be appreciated that other communication mechanisms appropriate to local communication could also be employed.

In an alternative embodiment of the present invention shown in FIG. 4, the data store of the electronic whiteboard (2) can be accessed via an Internet server (26) acting as an HTTP gateway to the data store (6). In this case the whiteboard (2) would not have an Internet server incorporated within it. In this case the URL of the server (26) would be that required to access the images recorded in the data store (6). The images stored in the data store (6) of the whiteboard (2) could be copied into a data store or cache (28) associated with the server (26) and it would be data store (28) which is accessed remotely by a user inputting the URL of the server (26). For example, an attendee (30) at a meeting at which the whiteboard (2) was used and wanting to access and download the images which had been recorded on the whiteboard at the meeting would require the URL of the server (26). The URL of the server (26) could be emitted by a beacon associated with the whiteboard (2) as discussed above in relation to FIG. 2, or could be encoded in a bar- code or electronic tag associated with the whiteboard (2) as discussed above in relation to FIG. 3. The attendee (30) could use a computing device (32) connected to the Internet to access and download the images recorded on the whiteboard (2) during the meeting. The URL of the server (26) could have been manually input into the computing device (32), for example, at the beginning of the meeting, or could have been stored by the computing device (32) at the meeting, via a beacon, bar-code or electronic tag.

Again, in the embodiment shown in FIG. 4, some means of providing security to the data store (28) of server (26) would have to be implemented in order to preserve its confidentiality. In addition, some way of locating the desired file within a number of files contained within the data store (28) of the server (26) would have to be used, for example as described above.

When the electronic whiteboard (2) is first set up an Internet location is associated with the server (4, 26) for the data store (6, 28). Thereafter, the images that are stored in the data store (6, 28) of the whiteboard (2) can be accessed over an Internet connection by inputting the Internet location of the server (4, 26) into a web browser.

1. An electronic whiteboard comprising:
a surface for recording of images;
a data store for storing images which are recorded on the surface, wherein the data store has a presence on a network via a network location; and
a communication system for communicating to individuals or computing devices within its locality the network location of the data store.

2. An electronic whiteboard according to claim 2, wherein the communication system comprises a beacon for emitting a signal from which the network location associated with the data store can be derived.

3. An electronic whiteboard according to claim 2, wherein the beacon is an infrared beacon.

4. An electronic whiteboard according to claim 1, wherein the communication system comprises an electronic tag from which the network location associated with the data store can be derived.

5. An electronic whiteboard according to claim 1 wherein the data store has a presence on a network via a remote server which forms a gateway between the network and the data store and the remote server has a presence on the network via a network location.

6. An electronic whiteboard according to claim 1, incorporating a network server having a network location for providing access to the data store via the network.

7. An electronic whiteboard according to claim 1 wherein the data store stores images recorded on the whiteboard periodically.

8. An electronic whiteboard according to claim 7 wherein the data store stores images recorded on the whiteboard in real time.

9. An electronic whiteboard according to claim 1 wherein the network location is a URL.

10. A method of operating an electronic whiteboard, comprising:
presenting a surface of the electronic whiteboard for recording of information;
storing images recorded on the surface in a data store, and providing a network location for accessing images in said data store; and
communicating the network location to potential recipients in the vicinity of the electronic whiteboard.

11. A method as claimed in claim 10, wherein communicating the network location comprises emitting a beacon signal from which the network location associated with the data store can be derived.

12. A method as claimed in claim 11, wherein the beacon signal is an infrared beacon signal.
